(19) United States
(12) Patent Application Publication
(10) Pub. No.: US 2013/0132619 A1
(43) Pub. Date: May 23, 2013

(54) METHOD FOR REDUCING TRANSMISSION LATENCY AND CONTROL MODULE THEREOF

(71) Applicants: Wei-Yun Chang, New Taipei City (TW); Ying-Hung Tang, New Taipei City (TW); Chi-Che Tsai, New Taipei City (TW); Shu-Tzu Wang, New Taipei City (TW)

(72) Inventors: Wei-Yun Chang, New Taipei City (TW); Ying-Hung Tang, New Taipei City (TW); Chi-Che Tsai, New Taipei City (TW); Shu-Tzu Wang, New Taipei City (TW)

(21) Appl. No.: 13/663,479

(22) Filed: Oct. 30, 2012

(30) Foreign Application Priority Data
Nov. 18, 2011 (TW) 100142259

(51) Int. Cl. G06F 3/00

(52) U.S. Cl. 710/52

(57) ABSTRACT

A method for reducing transmission latency and a control module thereof are operated inside a host and at an external USB device. The method includes following steps: when the host receives an NRDY packet, storing a first data segment to be transferred by the host at the buffer storage unit inside the host; when the host receives an ERDY packet, capturing the first data segment stored at the buffer storage unit; and transferring the first data segment to the external USB device.

### CROSS-REFERENCE TO RELATED APPLICATION

This application claims the priority benefit of Taiwan application serial no. 100142259, filed on Nov. 18, 2011. The entirety of the above-mentioned patent application is hereby incorporated by reference herein and made a part of this specification.

### BACKGROUND OF THE INVENTION

1. Field of the Invention

The disclosure generally relates to a method for reducing transmission latency and control module thereof, and more particularly, to a method for reducing transmission latency and control module thereof applied between a host site and an external bus device.

2. Description of Related Art

Since launching the bus, it has been gradually become an indispensable vital interface as a PC peripheral due to the features of operation convenience, hot-swappable, plug and play (no need to install additional drivers). For the PC and handheld device today, the bus almost serves as a basic interface to transfer data. For example, the following important PC peripheral devices such as, mouse, keyboard, external hard drive, printer, flash drive, webcam, card reader and other important personal computer peripherals almost employ the bus interface to transfer data.

Among the buses, the second-generation universal serial bus (USB 2.0) is based on a unidirectional channel half-duplex mode for transferring data, while the third-generation universal serial bus (USB 3.0) is based on a double side directional channel full-duplex mode so as to more effectively transfer data to the destination. For the USB 2.0, the data rate of the physical layer is 480 Mbit/s, while the USB 3.0 advances the data rate for 10 times and reaches 5 Gbit/s. In comparison with the polling scheme of the original USB 2.0, the USB 3.0 uses a not ready mechanism (NRDY mechanism) with active notification and endpoint ready mechanism (ERDY mechanism). It should be noted that in following the external bus device means external USB device only.

### SUMMARY OF THE INVENTION

Accordingly, the disclosure is directed to a control module for reducing transmission latency disposed inside a host and connected to an external USB device. The control module includes a first communication port, a buffer storage unit and a processing unit. The processing unit is coupled to the first communication port and the buffer storage unit. When the external USB device transfers a not ready packet (NRDY packet) and the NRDY packet to the first communication port, the processing unit stores a first data segment to be transferred at the buffer storage unit; when the first communication port receives an endpoint ready packet (ERDY packet) transferred by the external USB device, the processing unit captures the first data segment stored at the buffer storage unit and then transfers the first data segment to the external USB device.

In an embodiment of the present disclosure, the above-mentioned first communication port supports universal serial bus 3.0 (USB 3.0).

In an embodiment of the present disclosure, the above-mentioned external USB device has a second communication port compliant with the USB 3.0 specification and the external USB device is connected to the first communication port through the second communication port for transferring a plurality of data segments.

In an embodiment of the present disclosure, the data throughput of each of the data segments among the above-mentioned data segments compliant with the USB 3.0 specification.

In an embodiment of the present disclosure, the above-mentioned host further includes a primary memory and a chip set, the primary memory is for storing the first data segment and the chip set is coupled to the primary memory and the control module.

The disclosure also provides a method for reducing transmission latency, which is operated inside a host and at an external USB device and includes following steps: first, when the host receives an NRDY packet, storing a first data segment to be transferred by the host at the buffer storage unit inside the host; next, when the host receives an ERDY packet, capturing the first data segment stored at the buffer storage unit and transferring the first data segment to the external USB device.

In an embodiment of the present disclosure, the above-mentioned NRDY packet and ERDY packet are sent out by the external USB device.

In an embodiment of the present disclosure, the above-mentioned external USB device is a USB 3.0.

Based on the description above, the disclosure provides a method for reducing transmission latency and a control module thereof, which takes advantage of the feature for the buffer storage unit to register data to be transferred so as to effectively reduce the transmission latency from the host site to the external USB device. The reduced time of transmission latency is able to advance overall transmission efficiency.

In order to make the features and advantages of the present disclosure more comprehensible, the present disclosure is further described in detail in the following with reference to the embodiments and the accompanying drawings.

### BRIEF DESCRIPTION OF THE DRAWINGS

FIG. 1 is a schematic diagram showing a transmission latency situation.

FIG. 2 is a schematic diagram for capturing data in a storage device by using a device context base address array method (DCBAA method).

FIG. 3 is a function block diagram of a control module for reducing transmission latency according to an embodiment of the disclosure.

FIG. 4 is a flowchart of a method for reducing transmission latency according to an embodiment of the disclosure.

FIG. 5 is a schematic diagram showing reducing the transmission latency according to an embodiment of the disclosure.

### DESCRIPTION OF THE EMBODIMENTS

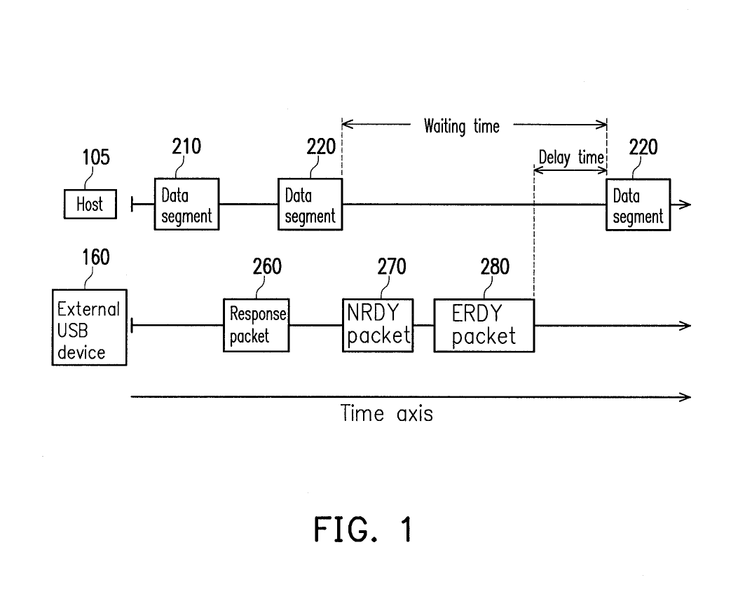

FIG. 1 is a schematic diagram showing a transmission latency situation where a data transmission is present on time axis between a host 105 and an external USB device 160. The data throughput of each data segment among a plurality of data segments compliant with the USB 3.0 specification. First, the host 105 sends out a data segment 210. When the external USB device 160 receives the data segment 210 a response packet 260 is returned to the host 105, in which the response packet includes a common acknowledgement mechanism (Ack mechanism) in the regular communication field.

After the host 105 receives the response packet 260 from the external USB device 160, the host 105 would transfer a next data segment 220 to the external USB device 160. At the time, if the external USB device 160 is temporarily unable to execute the receiving data segment, the external USB device 160 would send out an NRDY packet 270 to the host 105 to inform the host 105 of the present state of failing to smoothly receive the data segment. When the external USB device 160 resumes the state of going on receiving the data segment, an ERDY packet 280 is sent out to inform the host 105 of that it can go on receiving the data segment at the moment, so that the host 105 resends the data segment 220 to the external USB device 160. The NRDY packet herein is compliant with the NRDY mechanism under the common USB 3.0 specification, while the ERDY packet is compliant with the ERDY mechanism under the common USB 3.0 specification.

In terms of the host 105, it has entered the latency state after sending out the data segment 220 first time to wait for the acknowledgement by the external USB device 160. However, as described above, the one responded by the external USB device 160 is the NRDY packet 270, thus, the host 105 continues waiting. Then, once the ERDY packet 280 is received, according to the regular data transmission mechanism between the host 105 and the external USB device 160, the host 105 needs to search again and capture the data in the memory by using the device context base address array method (DCBAA method). Only after founding and capturing the data in the memory, the data segment 220 is retransferred again in the second times.

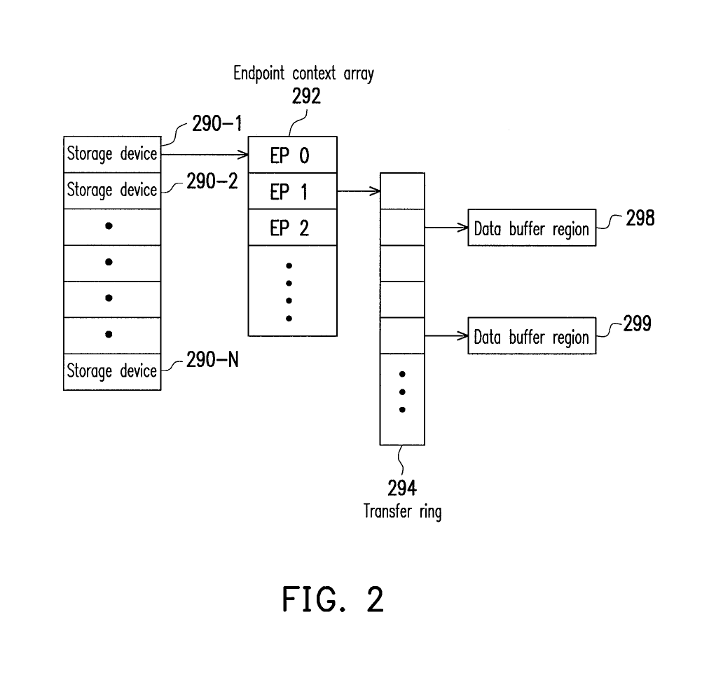

FIG. 2 is a schematic diagram for capturing data in a storage device by using the DCBAA method. Referring to FIG. 2, it is first to find out the storage devices 290-1 until 290-N of the data segment to be transferred and then to find out the corresponding endpoint context array 292, followed by capturing data in a data buffer region 298 or a data buffer region 299 through a transfer ring 294. That is to say if the host 105 terminates transferring data due to receiving the NRDY packet 270, it is needed to conduct the above-mentioned steps again to capture data to resume the transferring data. Therefore, the waiting time of the host 105 must plus an additional time delay produced for re-obtaining the data, which leads to a longer time consumption and delay for transferring data segments.

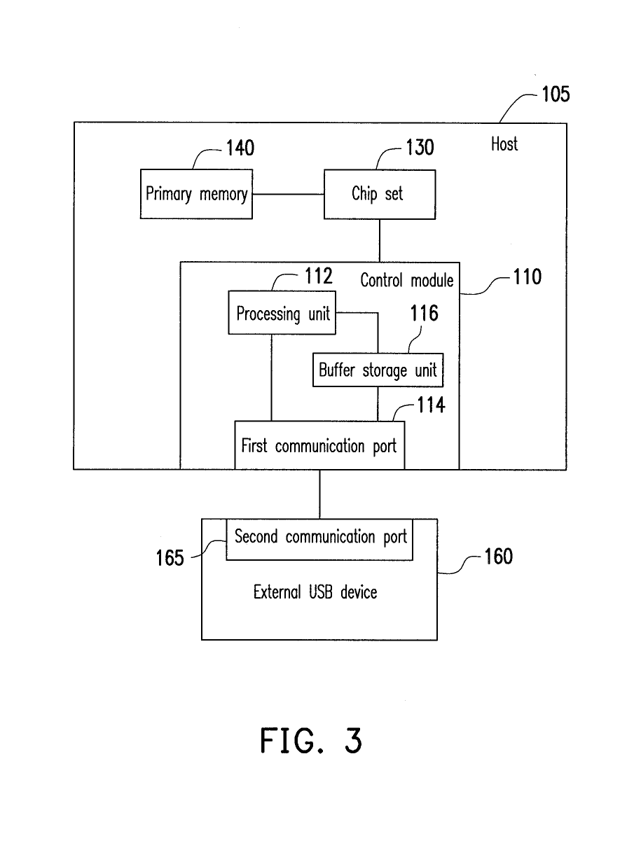

FIG. 3 is a function block diagram of a control module for reducing transmission latency according to an embodiment of the disclosure. The control module 110 herein is operated inside the host 105 and adapted to reduce the transmission latency between the host 105 and the external USB device 160 connected to the host 105. The external USB device 160 is, for example, an electronic device compliant with the USB 3.0 specification such as a flash drive or a USB external hard drive. The control module 110 includes a processing unit 112, a first communication port 114 and a buffer storage unit 116, in which the processing unit 112 is coupled to the first communication port 114 and the buffer storage unit 116 and can be hardware electronic devices or software applications. In addition, in the embodiment of the disclosure, the first communication port 114 can be compliant with the USB 3.0 specification.

The external USB device 160 further has a second communication port 165 compliant with the USB 3.0 specification. The external USB device 160 connects to the first communication port 114 of the control module 110 through the second communication port 165 for transferring data segments between the host 105 and the external USB device 160.

In the embodiment, the host 105 further includes a chip set 130 and a primary memory 140, in which the chip set 130 is coupled to the control module 110 and the primary memory 140. In general, the chip set 130 disposed in the host 105 is the data transmission interface between the primary memory 140 and the control module 110. For regular transferring data between the host 105 and the external USB device 160, the control module 110 captures data from the primary memory 140 through the chip set 130, followed by transferring data to the external USB device 160 through the first communication port 114.

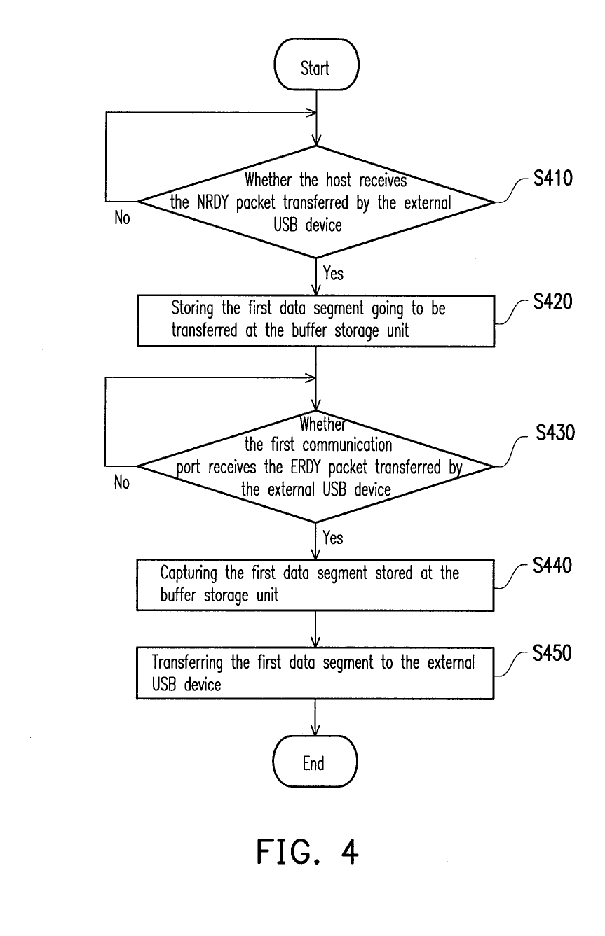

The disclosure further provides a method for reducing transmission latency to reduce the above-mentioned problem. FIG. 4 is a flowchart of a method for reducing transmission latency according to an embodiment of the disclosure. The processing unit 112 detects the host 105 to make sure whether or not the NRDY packet transferred by the external USB device 160 is received (step S410). If, according to the judgement of step S410, the NRDY packet transferred by the external USB device 160 is received, the host 105 stores the first data segment going to be transferred at the buffer storage unit 116 (step S420). Then, the processing unit 112 detects the first communication port 114 whether the ERDY packet transferred by the external USB device 160 is received (step S430). If, according to the judgement of step S430, the ERDY packet transferred by the external USB device 160 is received, the processing unit 112 captures the first data segment stored at the buffer storage unit 116 (step S440), and the processing unit 112 controls the first communication port 114 to transfer the first data segment to the external USB device 160 (step S450).

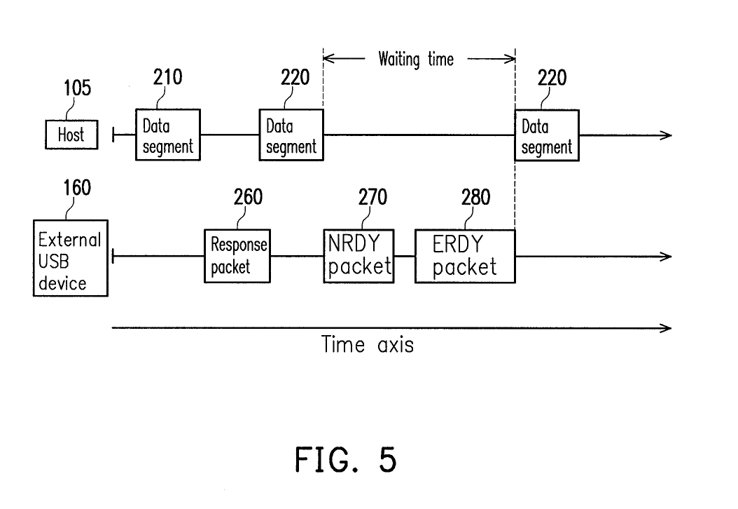

FIG. 5 is a schematic diagram showing reducing the transmission latency according to an embodiment of the disclosure. According to the method for reducing transmission latency of the disclosure, the control module 110 has an additional buffer storage unit 116. When the host 105 sends out a data segment (for example the data segment 220 in FIG. 2) to the external USB device 160, the external USB device 160 would send out an NRDY packet 270 and an ERDY packet 280. Once the host 105 receives the ERDY packet 280, the processing unit 112 directly captures the data segment 220 from the buffer storage unit 116, followed by sending out the data segment 220 from the first communication port 114 without using the DCBAA method to search the data. Therefore, the data transmission between the host 105 and the external USB device 160 in the embodiment is more efficient. In other words, by comparing FIG. 5 with FIG. 1, the method for reducing transmission latency provided by the disclosure, over the scheme of FIG. 1 where the data is captured by using a common DCBAA method, can reduce the time delay and the data segment 220 can be faster delivered.

In summary, the disclosure provides a method for reducing transmission latency and a control module thereof, which takes advantage of the feature for the buffer storage unit to register data to be transferred so as to immediately transfer the data segment to be sent out in a waiting time once a normal transmission between the host and the external USB device is resumed. In this way, the disclosure can effectively reduce the transmission latency from the host site to the external USB device without re-search data through the conventional DCBAA method, and thus, the disclosure can reduce the time delay and advance the transmission efficiency.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A control module for reducing transmission latency, disposed inside a host and connected to an external USB device, wherein the control module comprising:
a first communication port;
a buffer storage unit; and
a processing unit, coupled to the first communication port and the buffer storage unit;
wherein when the external USB device transfers a not ready packet to the first communication port, the processing unit stores a first data segment to be transferred at the buffer storage unit, when the first communication port receives an endpoint ready packet transferred by the external USB device, the processing unit captures the first data segment stored at the buffer storage unit and then transfers the first data segment to the external USB device.

2. The control module for reducing transmission latency as claimed in claim 1, wherein the first communication port supports universal serial bus 3.0.

3. The control module for reducing transmission latency as claimed in claim 2, wherein the external USB device has a second communication port and the second communication port is connected to the first communication port for transferring a plurality of data segments.

4. The control module for reducing transmission latency as claimed in claim 3, wherein the second communication port supports the universal serial bus 3.0.

5. The control module for reducing transmission latency as claimed in claim 1, wherein the host further comprises:
a primary memory, for storing the first data segment; and
a chip set, coupled to the primary memory and the control module.

6. A method for reducing transmission latency, operated inside a host and at an external USB device and comprising:
when the host receives a not ready packet, storing a first data segment to be transferred by the host at the buffer storage unit inside the host;
when the host receives an endpoint ready packet, capturing the first data segment stored at the buffer storage unit; and
transferring the first data segment to the external USB device.

7. The control method for reducing transmission latency as claimed in claim 6, wherein the not ready packet and the endpoint ready packet are sent out by the external USB device.

8. The control method for reducing transmission latency as claimed in claim 6, wherein the external USB device is a flash drive or an external hard drive both supporting universal serial bus 3.0.

9. The control method for reducing transmission latency as claimed in claim 6, wherein the external USB device has a second communication port, and the second communication port is connected to a first communication port of the host to transfer the first data segment.

10. The control method for reducing transmission latency as claimed in claim 9, wherein the second communication port supports the universal serial bus 3.0.
